(19) United States
(12) Patent Application Publication
(10) Pub. No.: US 2010/0227601 A1
(43) Pub. Date: Sep. 9, 2010

(54) System for Inhibiting Wireless Communication

(76) Inventors: Randy Walton, Aydlett, NC (US); David W. Hughes, Kitty Hawk, ND (US)

Correspondence Address: GREENBERG & LIEBERMAN, LLC, 2141 WISCONSIN AVE, N.W., SUITE C-2, WASHINGTON, DC, 20007, US

(21) Appl. No.: 12/400,473

(22) Filed: Mar. 9, 2009

(51) Int. Cl. H04M 3/00; H04B 7/00

(52) U.S. Cl. 455/418; 455/41.2

(57) ABSTRACT

A system for inhibiting functions of select wireless communications devices—predominately for driver cell phones—through the use of a radio frequency transmitter synchronized with a software application that is downloaded into the cell phone or provided by the manufacturer in firmware or the operating system of the phone. The radio frequency transmitter is wired into the power supply of the vehicle and its signal is only emitted and received by the cell phone when the vehicle's power is flowing. When the cell phone receives the unique signal, the software application disables most communications and other distracting functions of the cell phone. The radio frequency transmitter also may be portable and plugged into a wall socket so that wireless communication in select rooms is inhibited when the circuit is closed.

### FIELD OF THE INVENTION

The present invention relates to a cell phone inhibitor comprising of a transmitter powered and connected to a vehicle while a software application synchronizes select cell phones to the transmitter signal to ultimately inhibit its use while the vehicle is running. The radio frequency transmitter may be portable and plugged into a wall socket so that wireless communication in select rooms is inhibited when the circuit is closed.

### BACKGROUND OF THE INVENTION

Teenage drivers have always been a source of concern. Recent U.S. Department of Health and Human Services statistics demonstrate that vehicle accidents are the leading cause of death for U.S. teenagers. In addition, persons aged 15 to 24, who represent only 14 percent of the U.S. population, account for 30 percent ($19 billion) of the total costs of motor vehicle injuries among males and 28 percent ($7 billion) of the total costs of motor vehicle injuries among females. With the advent of cellular technology, officials are noticing even worse trends due to the inherent distractions associated with cell phone use. This fact has prompted a number of jurisdictions to pursue various degrees of prohibitions on teenage cell phone use while driving. Other jurisdictions, such as U.S. military installations, go so far as to prohibit cell phone use or all drivers.

Along with the driving statistics, cell phones are becoming as commonplace with teenagers and other people as wallets and purses. Cell phones are important possessions in cases of emergency, for example. Because this factor conflicts with a teenager's proven tendency to use cell phones while driving, there remains a need for a method that prevents certain drivers from making non-emergency cell phone communications while the vehicle is running.

An additional element is that typical cell phone jammers are illegal in the U.S. and other jurisdictions. Since extraneous issues relating to cell phone use remains prevalent with not only drivers, but also in places of business and schools, there is a need for a cell phone specific inhibitor that inhibits most cell phone usage in a designated area with the full complicity and permission of the owner or supervisor.

There are various products and services that attempt to deal with cell phone use while driving. For example, WQN Inc. offers a service where GPS is used to tell how fast a vehicle is moving in order to inhibit a cell phone. However, unlike the present invention, WQN cannot distinguish between cell phones in the vehicle and may therefore needlessly inhibit all phones. In contrast, the present invention utilizes unique radio transmission frequencies in correlation to specific software applications downloaded into the wireless communication device. In addition, the installation and components associated with the present invention are much more cost effective and do not require the outside service of a GPS system. This also is true of other services to include DriveAssistT by Aegis Mobile.

U.S. Pat. No. 6,496,703 issued to Da Silva on Dec. 17, 2002, is a system for disabling wireless communication devices. Da Silva attempts to create zones to disable cell phone communication through the use of power monitoring units and position monitoring systems. Unlike the present invention, Da Silva employs relatively costly and macro-type systems in order to disable wireless communications in the designated zones. The present invention, in contrast, does not require such complex resources. Instead, the present invention utilizes the power of the individual vehicle to ultimately transmit information to the cell phone via software application. From this, the present invention does not create disabled zones as is the case with Da Silva, but instead is wireless communications device specific and event specific ie when the vehicle is running.

U.S. Pat. No. 6,556,810 issued to Suzuki on Apr. 29, 2003, is a communications-inhibiting device for vehicles. Suzuki employs waves that seek to disrupt communications inside a vehicle. The waves in Suzuki also are capable of detecting speed and other factors. Unlike the present invention, Suzuki casts a wide net in that its waves are independent of individual cell phones and therefore will inhibit all communications from the vehicle. In contrast, the present invention utilizes the power of the individual vehicle to ultimately transmit information to a specific cell phone that is synchronized with designated software. In this manner, the present invention does not inhibit passengers who may wish to use a cell phone while Suzuki's wave device would disrupt all communications. Moreover, the present invention can distinguish between certain types of communications while Suzuki either inhibits communication or it doesn't. For example, the present invention would not disrupt a 911 emergency call because its inhibition procedure is not arbitrary but is, in fact, very specific and targeted.

### SUMMARY OF THE INVENTION

The present invention is comprised of a transmitter that works in conjunction with a wireless communication device software application to inhibit most cell phone functions while a vehicle is running. The transmitter is connected to the vehicle's accessory circuit and consequently receives its power when the vehicle is turned on. In the preferred embodiment of the present invention, the transmitter emits a radio frequency that can be picked up and recognized by a cell phone located within relative close proximity to the vehicle. This proximity typically is inside the vehicle. The cell phone recognizes the radio frequency from the transmitter via an encoded software program. This software program is placed onto the cell phone through a standard data transfer such as a download or can be provided by the manufacturer as part of the cell phone's firmware or operating system. It should be noted that the present invention pertains to most forms of wireless communication devices, including cell phones, pagers and laptop computers.

The software program is written in any most formats compatible to typical cell phones and other wireless communications devices. The software program is capable of disabling various designated functions of the specific cell phone that the software program has been downloaded. The software program is activated upon affirmative receipt of signal from the transmitter. The reciprocal data and communications stream on the cell phone recognizes the signal from the transmitter. Affected functions include disabling the cell phone's keypad, screen displays, ringers and other communications alert items. However, the software program merely disables these functions and does not interfere with the actual signals received by the cell phone or wireless communications device. Once the power is cut off to the transmitter relating to the running of the vehicle, the software program ceases to receive the inhibiting signal from the transmitter and the cell phone is again capable of full function.

Additional embodiments of the present invention include an additional trigger embedded in the software program. This activation trigger is encoded through text messaging and is received from the administrator of the cell phone. This embodiment of the present invention serves as a remote action for enabling or disabling the wireless communications device. A further additional embodiment consists of an encoded trigger within the software program that couples with time/date elements so that an administrator can activate or deactivate the software program at designated times. An additional embodiment of the present invention embeds an exception into the software program that permits certain designated calls such as emergency 911.

### BRIEF DESCRIPTION OF THE DRAWINGS

FIG. 1 is a flow chart of the present invention

FIG. 2 is a flow chart of an additional embodiment of the present invention

### DETAILED DESCRIPTION OF THE PREFERRED EMBODIMENT

The present invention is a system for inhibiting select wireless communication devices such as cell phones. The present invention makes use of a software application that is transferred via conventional data transfer means in the cell phone or also can be provided by the manufacturer as a part of the phone's firmware, operating system, and/or hardware itself. It should be understood that this application make reference to “the software application,” however, the application could, in an alternative embodiment, be a hardware application. If a hardware application, then the present invention could be mandated for use for the hardware to be operational when driving. The software application works in conjunction with a radio frequency transmitter connected to a vehicle to ultimately inhibit most functions of the cell phone while the vehicle is started. In addition to the preferred embodiment, the radio frequency transmitter that is used to trigger the software program of the present invention also may be used in other locations such as offices or schools.

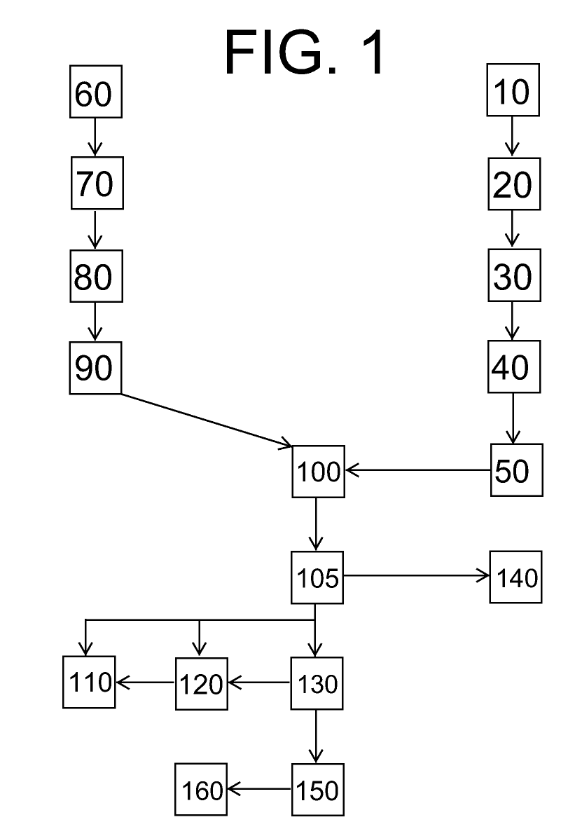

In FIG. 1, we see a flow chart of the present invention from beginning of the system to the end. The first step is for a cell phone activation (10). This typically means activation in terms of establishing a communications plan, along with physically turning the cell phone on. For purposes of the present invention, the cell phone is just one prominent example of a relevant device. Most other wireless communications devices, including pagers and laptops, also are capable of being employed through the present invention. As such, the term cell phone also is referred to as wireless communication device.

After the cell phone activation (10), the user downloads the software application (20). The download only needs to occur once and may come standard with certain cell phone plans. This download is conducted through conventional means. The software program itself can be written under the auspices of a number of operating systems used to embed the programmed applications into a device such as a cell phone. This includes—but is not limited to—Java™, Windows CE™ and Linux™. Under these operating system programs, the software application is written to respond to various radio frequencies received by cell phone once the cell phone activation (10) has occurred. Once the specific radio frequencies are detected, the software program is triggered to conduct its inhibiting functions. While the software application is only necessary to be downloaded (20) once, it can be deleted, deactivated or otherwise removed from the cell phone by the administrator with proper security credentials. If the software application is deleted or removed, it must be downloaded (20) again in the same manner described above if desired.

Once the software application is downloaded (20), the software application will automatically be triggered and ultimately synchronize with a specific radio frequency (30). The specific radio frequency will trigger the inhibiting function of the software application. Otherwise, the cell phone will function normally and uninhibited (40). The driver with the cell phone then would enter the vehicle (50) with the cell phone in his or her possession. The vehicle will likely be off (60) at this time.

To make the system of the present invention work, a radio frequency transmitter must be installed in the vehicle (70). The radio frequency transmitter is of conventional and known means, such as Blue Tooth™ technology. The radio frequency transmitter does not transmit radio frequencies very far, but is actually limited to transmit its signal the distance from where the physical radio frequency transmitter is installed inside the vehicle to a set area. This set area may be for the entire vehicle or merely to the vicinity of the driver's seat. In this manner, a person sitting in the backseat of the vehicle may still use the cell phone, while the driver may not operate the cell phone. The radio frequency transmitter also may be pointed and honed relating to the extent of its signal.

The radio frequency transmitter is installed in the vehicle (70) typically connected via known and conventional wiring to the vehicle's accessory box. This type of connection provides immediate power to the radio frequency transmitter as soon as the vehicle is turned on (80). Once the vehicle is turned on (80), the radio frequency transmitter transmits its unique signal (90). This unique signal (90) is the trigger that had been synchronized with a specific radio frequency (30) relating back to the software application. Once the radio frequency transmitter transmits its unique signal (90), it is received by the activated cell phone (100) that is located within range of the signal emanating from the radio frequency transmitter. The cell phone receives this signal through its typical data transmission receiver.

Once the signal is received by the activated cell phone (100), the software application is triggered (105). The software application is embedded in the overall operational program of the cell phone, so it automatically serves its inhibiting function. This includes disabling the cell phone keypad (110), disabling the cell phone ringer or other alerts (120) and disabling the cell phone display screen (130). These functions are disabled through the triggering of the software program so long as the radio frequency transmitter is emitting the unique signal in the vicinity of the cell phone. This means that if the driver pulls over and turns the vehicle off (150), the cell phone functions will be available again (160) because the triggering radio frequency transmitter would not be receiving power to transmit.

Moreover, when the power is on and the inhibiting effect is occurring, the system of the present invention does not interfere with the cell phone in terms of any internal tracking devices or ability to receive other signals. This means that as soon as the cell phone stops receiving the radio frequency signal, any missed calls, messages, voice mail or text messages that would have otherwise appeared without the inhibition will appear. In this manner, an additional embodiment of the present invention permits drivers to make such limited communications as emergency calls (140).

An additional embodiment of the present invention relates to the same process as described above, but in portable format. In this manner, the present invention can be detached from a vehicle, or come completely independent of the vehicle, and plugged into the power system of a fixed structure such as a building or house.

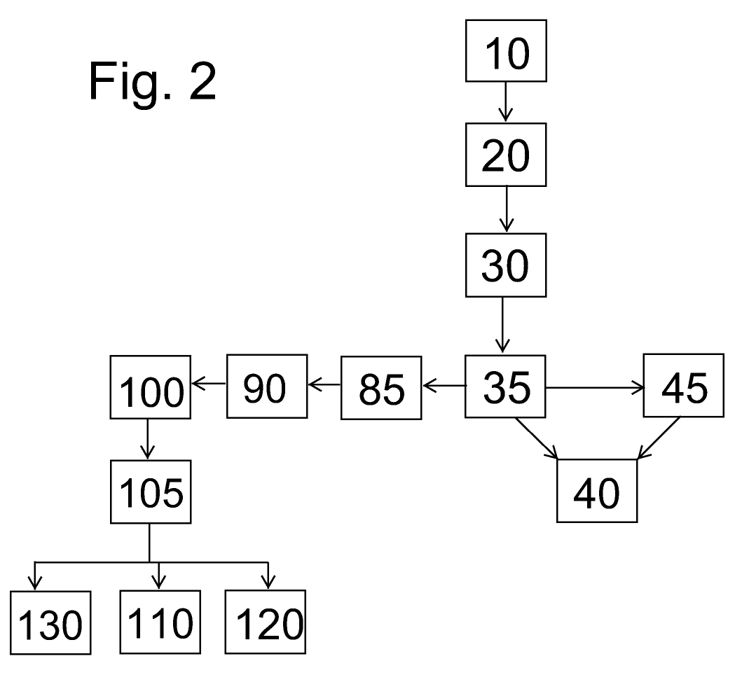

FIG. 2 offers a flow chart dealing with this alternative embodiment, which carries many of the same characteristics of the vehicle embodiment described above. After the cell phone activation (10), the user downloads the software application (20). Once the software application is downloaded (20), the software application will automatically be triggered and ultimately synchronize with a specific radio frequency (30). In this embodiment, the radio frequency transmitter is plugged into a standard wall socket (35). The specific radio frequency will trigger the inhibiting function of the software application. Otherwise, the cell phone will function normally and uninhibited (40). The radio frequency transmitter is plugged into a standard wall socket (35), meaning that it is connected to the electric wiring of the building or room. This type of connection provides immediate power to the radio frequency transmitter as soon as the circuit is closed. When the circuit is closed (85), power reaches the radio frequency transmitter as the radio frequency transmitter transmits its unique signal (90). Once the radio frequency transmitter transmits its unique signal (90), it is received by the activated cell phone (100) that is located within range of the signal emanating from the radio frequency transmitter.

The cell phone receives this signal through its typical data transmission receiver. Once the signal is received by the activated cell phone (100), the software application is triggered (105). The software application is embedded in the overall operational program of the cell phone, so it automatically serves its inhibiting function. This includes disabling the cell phone keypad (110), disabling the cell phone ringer or other alerts (120) and disabling the cell phone display screen (130). These functions are disabled through the triggering of the software program so long as the radio frequency transmitter is emitting the unique signal in the vicinity of the cell phone. If the circuit is opened (45), power is stopped and consequently, the radio frequency transmitter stops transmitting. In this embodiment, it is envisioned that the circuit may be opened and closed via a conventional switch.

The embodiment of FIG. 2 also limits the range of the radio frequency transmitter to the distance of a room or building. In this manner, places such as schools, offices, homes, prisons and top secret installations or briefing rooms can be secured through the use of ceasing all transmissions. In both embodiments of the present invention, it is envisioned that the software application be equipped with a conventional timing device so that the radio frequency transmissions operate and are effective during certain blocks of time. Examples include nighttime hours or school hours.

It should be understood that the software is not specific in nature, and that the software is conventional in nature. It is the features and arrangement of the system that are deemed patentable.

We claim:

1. A system for inhibiting mobile phone communication, comprising:
transferring a software application via conventional data transfer into a wireless communication device;
connecting a radio frequency transmitter to a vehicle such that the radio frequency transmitter works in conjunction with the software application;
limiting transmission range of the radio frequency transmitter to no farther than the interior of the vehicle;
detecting radio frequencies via the wireless communication device;
triggering the software application to initiate upon detecting specific radio frequencies; and
synchronizing the software application with the specific radio frequency after the software application is initiated, causing the software application to inhibit the wireless communication device.

2. The system for inhibiting mobile phone communication of claim 1, further comprising installing the radio frequency transmitter to an accessory box of the vehicle.

3. The system for inhibiting mobile phone communication of claim 2, further comprising providing immediate power to the radio frequency transmitter once the vehicle is turned on.

4. The system for inhibiting mobile phone communication of claim 3, further comprising transmitting the specific radio frequency via the radio frequency transmitter once the vehicle is turned on.

5. The system for inhibiting mobile phone communication of claim 1, further comprising transmitting the specific radio frequency from the radio frequency to the wireless communication device, the wireless communication device receiving the specific radio signal once the wireless communication device is activated.

6. The system for inhibiting mobile phone communication of claim 1, further comprising embedding the software application into an overall operational program of the wireless communication device such that an inhibiting function occurs.

7. The system for inhibiting mobile phone communication of claim 6, further comprising disabling a keypad, ringer or other alert mechanism, and display screen of the wireless communication device so long as the radio frequency transmitter is emitting the specific radio frequency into the wireless communication device.

8. The system for inhibiting mobile phone communication of claim 1, further comprising permitting emergency communications via the wireless communication device while the specific radio frequency is being transmitted.

9. The system for inhibiting mobile phone communication of claim 1, further comprising downloading the software application to the wireless communication device.

10. The system for inhibiting mobile phone communication of claim 1, further comprising removing the software application from the wireless communication device by an administrator with proper security credentials.

11. The system for inhibiting mobile phone communication of claim 1, further comprising writing the software application to respond to the specific radio frequency to be received by the wireless communication device.

12. A system for inhibiting mobile phone communication, comprising:
transferring a software application via conventional data transfer into a wireless communication device;
connecting a radio frequency transmitter to a vehicle such that the radio frequency transmitter works in conjunction with the software application;
limiting transmission range of the radio frequency transmitter to no farther than the interior of the vehicle;
detecting radio frequencies via the wireless communication device;
triggering the software application to initiate upon detecting specific radio frequencies;
synchronizing the software application with the specific radio frequency after the software application is initiated, causing the software application to inhibit the wireless communication device;
further comprising installing the radio frequency transmitter to an accessory box of the vehicle;
further comprising providing immediate power to the radio frequency transmitter once the vehicle is turned on;
further comprising transmitting the specific radio frequency via the radio frequency transmitter once the vehicle is turned on;
further comprising transmitting the specific radio frequency from the radio frequency to the wireless communication device, the wireless communication device receiving the specific radio signal once the wireless communication device is activated;
further comprising embedding the software application into an overall operational program of the wireless communication device such that an inhibiting function occurs;
further comprising disabling a keypad, ringer or other alert mechanism, and display screen of the wireless communication device so long as the radio frequency transmitter is emitting the specific radio frequency into the wireless communication device;
further comprising permitting emergency communications via the wireless communication device while the specific radio frequency is being transmitted;
further comprising downloading the software application to the wireless communication device;
further comprising removing the software application from the wireless communication device by an administrator with proper security credentials;
further comprising writing the software application to respond to the specific radio frequency to be received by the wireless communication device; and
further comprising detaching the radio frequency transmitter from the vehicle so that the radio frequency transmitter can be plugged into a wall socket such that the radio frequency transmitter works in conjunction with the software application.

13. A system for inhibiting mobile phone communication, comprising:
transferring a software application via conventional data transfer into a wireless communication device;
plugging a radio frequency transmitter to a wall socket such that the radio frequency transmitter works in conjunction with the software application;
limiting transmission range of the radio frequency transmitter to no farther than the interior of the room;
detecting radio frequencies via the wireless communication device;
triggering the software application to initiate upon detecting specific radio frequencies; and
synchronizing the software application with the specific radio frequency after the software application is initiated, causing the software application to inhibit the wireless communication device.

14. The system for inhibiting mobile phone communication of claim 13, further comprising detaching the radio frequency transmitter from a vehicle so that the radio frequency transmitter can be plugged into the wall socket such that the radio frequency transmitter works in conjunction with the software application.

15. The system for inhibiting mobile phone communication of claim 1, further comprising detaching the radio frequency transmitter from the vehicle so that the radio frequency transmitter can be plugged into a wall socket such that the radio frequency transmitter works in conjunction with the software application.
